(19) United States
(12) Patent Application Publication
(10) Pub. No.: US 2009/0299980 A1
(43) Pub. Date: Dec. 3, 2009

(54) METHOD FOR SEARCHING AND DISPLAYING CONTENT IN A DIRECTORY

(76) Inventor: Sultrix Eros Marcus, Astoria, NY (US)

Correspondence Address: Sultrix Marcus, 34-34 24th Street #1F, Astoria, NY, 11106, US

(21) Appl. No.: 12/475,516

(22) Filed: May 30, 2009

Related U.S. Application Data
(60) Provisional application No. 61/130,534, filed on May 30, 2008.

(51) Int. Cl. G06F 17/30

(52) U.S. Cl. 707/3; 707/E17.108

(57) ABSTRACT

An improved system and methods for searching and displaying content in a directory having a single-action process which instantaneously displays search results solely of items open and operating at the exact time of the search request, within close proximity of the requester. An exemplary method may comprise the steps of: entering keyword (10) and location (11) information into a business directory, and initiating a search query (26). In a single-action (13), extracting (14) information from the search query (26) and searching within the business directory database (16) for related items. Subsequently, displaying clearly marked results of businesses related to the keyword (10), location (1), local time, and proximity (18) of the search query (26). Each search result item is clearly marked enabling an observer, at first glance, to quickly determine which items displayed are live, open and within the desired proximity. Thus, eliminating having to initiate further actions to retrieve more specific desired information.

### CROSS REFERENCE TO RELATED APPLICATIONS

This application claims the benefit of provisional patent application RESEARCH. No. 61/130,534, filed 2008 May 30 by present inventor.

### FEDERALLY SPONSORED RESEARCH

Not Applicable

### SEQUENCE LISTING OR PROGRAM

Not Applicable

### BACKGROUND OF THE INVENTION

1. Field

This application relates to the field of search engines, and more specifically an improved method for searching and displaying content in a directory.

2. Prior Art

It is not unusual for search engines to identify thousands, if not millions of items as the outcome of a single search query. These results are bundled and presented to the user in groups of 10 to 25.

Originally online search engines only generated results related to the keyword inputted by the consumer and the general area of the consumer. The consumer is automatically presented the first group/page of sites, then must request additional listings to further narrow their search. The process continues until the options are reduced to a manageable size and the consumer is transported to the desired item or website.

A drawback to the above approach is, when a consumer initiates a search query for a product or service, they are most often looking for businesses that are open and operating at the time of the query so that they can obtain information quickly and/or make a purchase. This makes searching for businesses difficult.

This problem has been partially solved by the implementation of time translations, U.S. Pat. No. 6,826,121 B1 to Olexa, 2004 Nov. 30, but these had and still have significant problems offering limited number of options for the consumer.

U.S. Pat. No. 6,826,121 B1 to Olexa, 2004 Nov. 30 shows a typical search wherein a keyword ‘restaurant’ has been typed. The results are presented as a listing of restaurants meeting the search criteria. Adjacent to each ‘hit’ is a click button to bring up an info sheet, a listing, or to contact the business establishment.

In the prior art, one of the search criteria ‘business hours of operation’ is shown as a table placed on the right side of the info sheet of a selected business profile. Using the prior art, consumers click on a business listing, which takes them to a business profile which has a link on the profile, when clicked, displays the hours of operation table. Consumer then can compare the time in the timetable to their own time zone to determine if the business is trading at the time of the query.

This partially solved the problem because, although the prior art displayed the hours of operation table within the info sheet on the right side of a selected business profile, the consumer is still faced with the problem of going through a plurality of steps to find the desired local business open at the time of the query.

This method can be cumbersome if you consider the thousands, if not millions of websites as the outcome to a single search query. Currently, search engines only displays search results related to the keyword, in this case ‘restaurant’ and the general area of the consumer. This presents several disadvantages:
(a) The consumer must go through each business listing result.
(b) The consumer must click on a listing to display more information about the selected listing.
(c) Then the consumer must click again within the selected listing to display the website.
(d) The consumer must click through the website to find the info sheet containing the hours of operation table.
(e) Assuming an hours of operation table exists on the selected website, the consumer must compare the hours of operation table to their local time zone to determine if the business is open and operating at the time of the query;

In most cases there is no existing info sheet and there is no hours of operation table. Currently consumers-seeking a product or service locally must call the business to see if the business is open and operating. If the business is not open then the consumer must begin the online search all over again and further refine the criteria.

### SUMMARY

In accordance with one embodiment a single-action search process which displays related search results of items open and operating at the time of the search query and within close proximity of the desired location. Each search result item is clearly marked enabling an observer, at first glance, to quickly determine which items displayed are live, open and within the desired proximity. Thus, eliminating having to initiate further actions to retrieve more specific desired information experienced by some prior-art search engines.

### DRAWINGS

### Figures

In the illustrations, drawings and screenshots closely related figures have the number but different alphabetic suffixes.

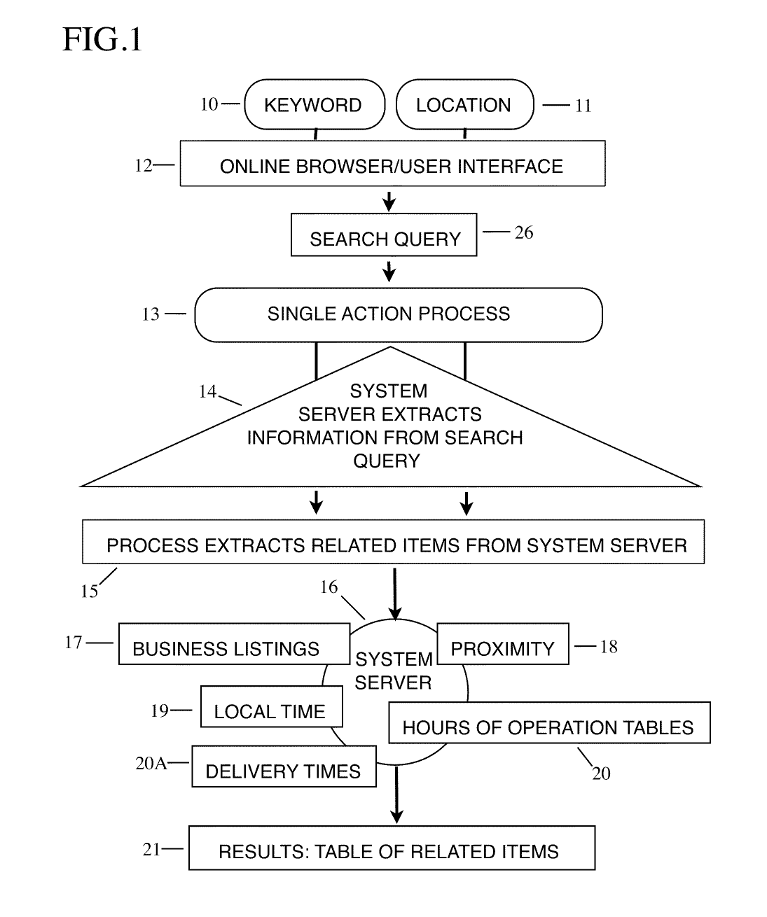

FIG. 1 show a flow diagram of the single-action searching process in one embodiment.

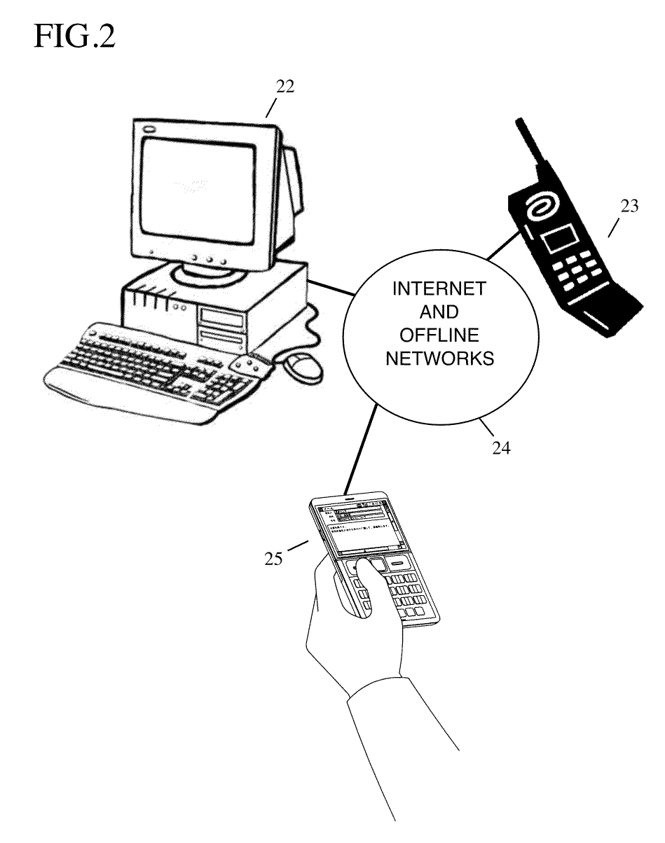

FIG. 2 show a pictorial representation of a computer, a cellular phone, and a hand held device connected to the internet which can be implemented in accordance with the method and system of the present process.

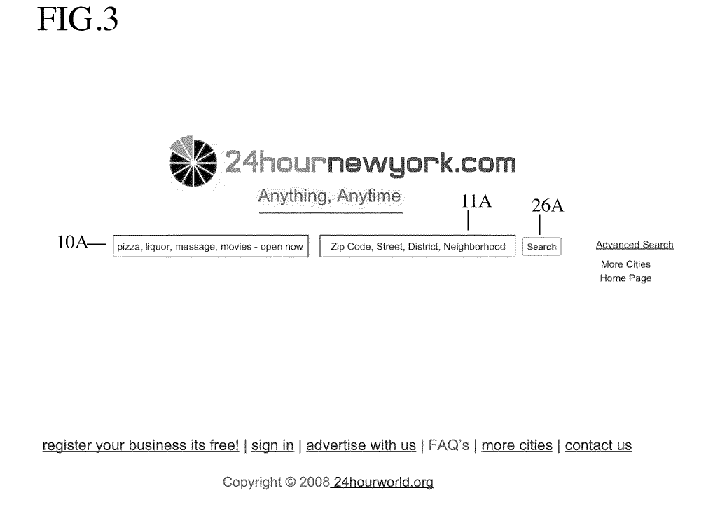

FIG. 3 show a home screen of 24hournewyork.com with fields where a consumer can input desired search criteria.

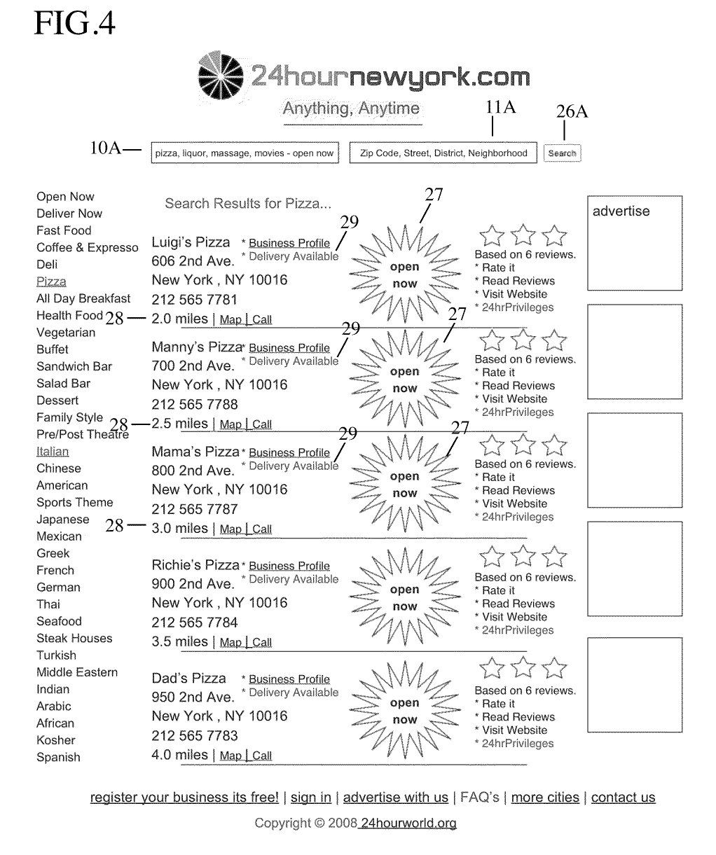

FIG. 4 show a search result screen displaying business listings which appear when a consumer inputs desired search criteria and hits the search icon of FIG. 3.

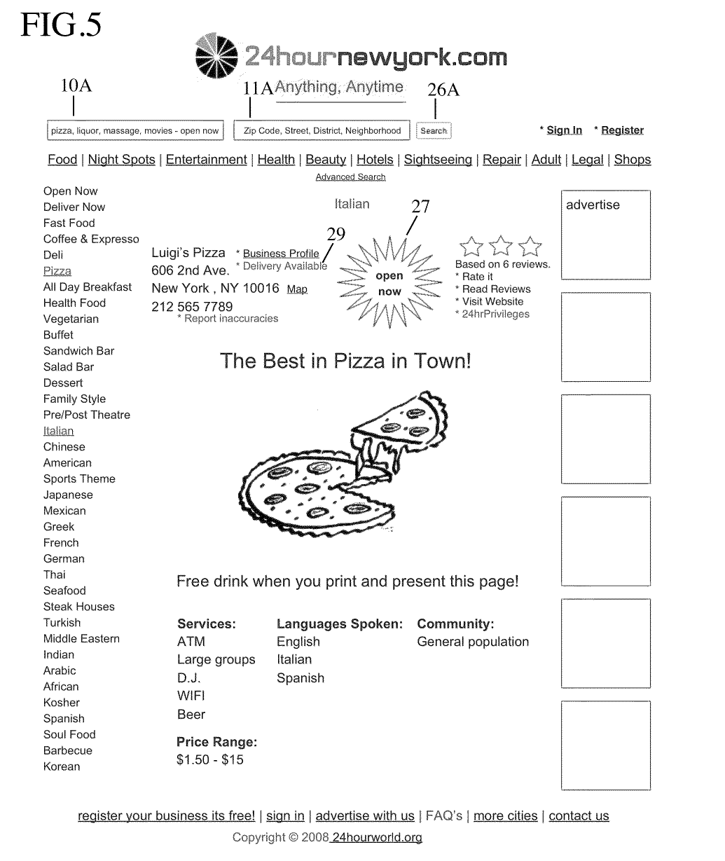

FIG. 5 show a business profile page that appears when a consumer hits a desired business listing of FIG. 4.

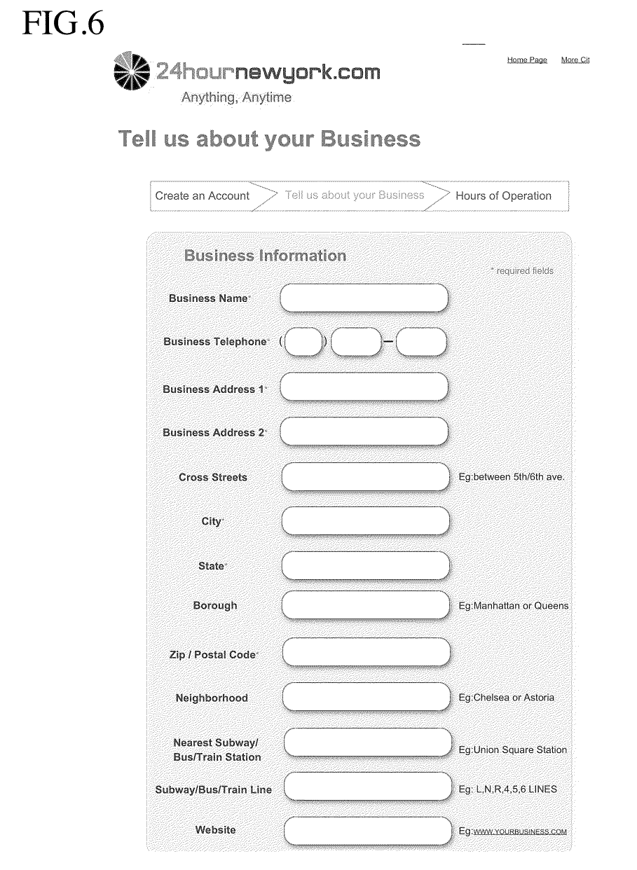

FIG. 6 show a business information form where a business can input business details to be stored in the system server enabling them to be part of search results of FIG. 4.

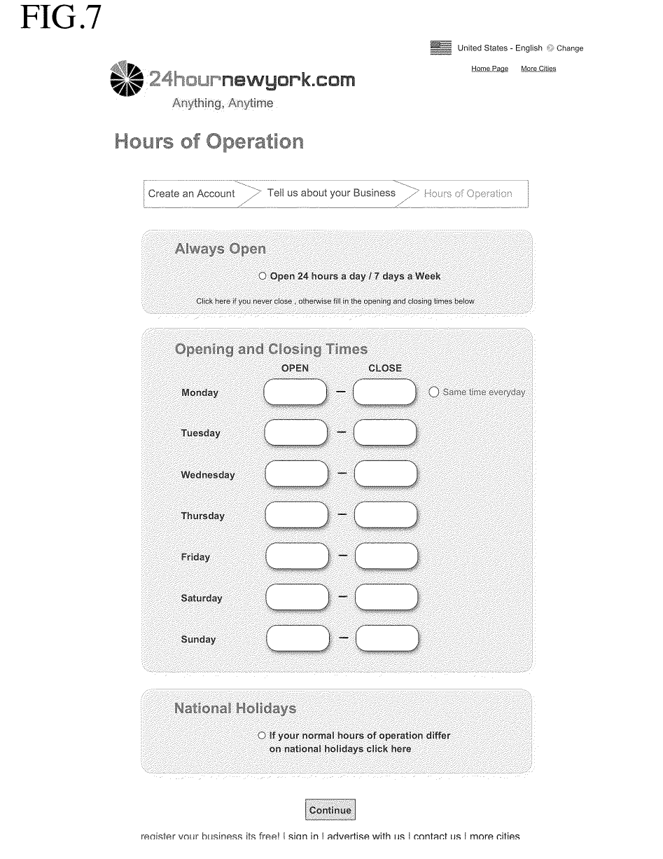

FIG. 7 show a continuation of the business information form of FIG. 6 featuring input fields for a business hours of operation.

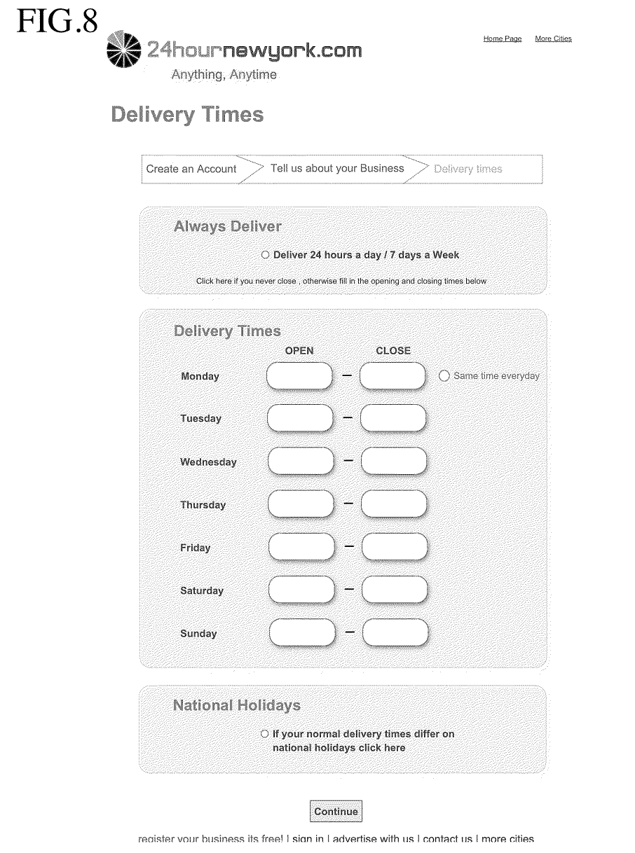

FIG. 8 show a continuation of the business information form of FIG. 7 featuring input fields for delivery times of a business.

### REFERENCE NUMERALS

10 keyword
10A keyword input box
11 location
11A location input box
12 online browser/user interface
13 single action process
14 system server extracts information from search query
15 process extracts related items from system server
16 system server
17 business listings
18 proximity
19 local time
20 hours of operation tables
20A delivery times
21 results: table of related items
22 computer
23 cell phone
24 internet and offline networks
25 hand held device
26 search query
26A search command icon
27 open now icon
28 proximity indicator
29 delivery indicator

### DETAILED DESCRIPTION

FIG. 1 illustrates the single-action search method in one embodiment of the present process. A requester initiates a search inquiry by entering keyword 10 and location 11 information into an online browser or a user interface 12. The requester clicks on a link to submit the search query 26 to the present process 13. In a single-action 13, the present process 13 extracts 14 information from the search query 26 and searches within the system server 16 for businesses listings 17 related to the keyword 10 and location 11.

The hours of operation tables 20 of these resulting related business listings 17 are then compared to the local time 19 of the requester. Subsequently the proximity 18 is calculated between the resulting related business listings 17 and the location 11 initially inputted by the requester.

Under control of the single-action query 13, search results 21 are instantaneously displayed as a table of related items 21, encompassing a list of business listings 17, related to the keyword 10 which are open and operating at the local time 19 of the search query 26, within close proximity 18 of the location 11 inputted by the requester. Where applicable, delivery times 20A of the related businesses are compared to the local time 19 of the search query 26, and results are included in the table 21.

FIG. 2 shows a pictorial representation of a computer 22, a cellular phone 23, and a hand held device 25 connected to the internet 24 which can be implemented in accordance with the method and system of the present process. The system includes a server computer that is connected to a computer network, such as the Internet or an IP-based computer network. The server computer includes a server memory that stores information pertaining to business details and hours of operation.

FIG. 3 show a screenshot of 24hournewyork.com displaying a user interface window in which a sample World Wide Web page is displayed in accordance with the method and system of the present process. A user interface is a type of display format that enables a user to choose commands, start programs, and see list of files and other options by pointing to a pictorial representations and lists of menu items on the screen. Choices can generally be activated by either a keyboard or a mouse.

In the example window depicted in FIG. 3 two input boxes are provided where a user can enter desired search criteria in accordance with the method and system of the present process. The first box is the keyword input box 10A. The keyword input box 10A is provided to enter keywords. A keyword is a word or phrase entered into a search engine in an effort to get the search engine to return matching and relevant results. The keyword describes what the consumer is looking for i.e. Pizza.

The second box is the location input box 11A. The location input box is provided to input the desired area where the consumer wishes to search. Location can be entered as a city, state, street, postal/zip code, or neighborhood.

The third box is the search command icon 26A. The user clicks on the search command icon 26A after all search criteria has been entered in the keyword input box 10A and the location input box 11A. The search command icon 26A is linked to the present process. The single-action clicking of the search command icon 26A will initiate the search.

FIG. 4 show a search result page. The search result page is immediately generated after entering search criteria in the keyword input box 10A of FIG. 3, and the location input box 11A of FIG. 3, and clicking the search command icon 26A of FIG. 3. FIG. 4 show a screenshot of 24hournewyork.com displaying a user interface window as a sample World Wide Web page. The World Wide Web page in FIG. 4 displays a list of businesses and business information.

FIG. 4 show the present process displaying search results as a table containing business listings arranged by proximity. Proximity is shown by the proximity indicator 28. The business closest to the area entered in the location input box 11A of FIG. 3 will appear first and the business farthest to the location entered in the location input box 11A of FIG. 3 will appear last.

The proximity indicator 28 of FIG. 4 in accordance with the method and system of the present process, show values, i.e. miles, to calculate distance. The values indicate the distance between the location entered in the location input box 11A of FIG. 3 and the business. Western and European values can be used to calculate distance. The present process can also extract location information contained in the requesters IP address and in circumstances where a hand held device is being used the present process can use the GPS location on the hand held device to pinpoint where the user is in relation to the business, thus eliminating the need to initially enter location information.

FIG. 4 show the open now icon 27. The present process will clearly mark each business listing on the search result page by using a simple icon or term such as OPEN NOW 27. The present process displays the open now icon 27 in the search results to notify the consumer as to whether a business is operating or not operating at the time of the search query. Subsequently, if the business is not operating the present process will use a simple icon or term such as CLOSED. This will immediately alert the consumer that the business is not operating at the time of the search. Any combination of words, terms, phrases, or icons can be used to convey whether a business is operating or not operating.

FIG. 4 show the delivery indicator 28. The present process will clearly mark each business listing on the search result page by using a simple icon or term such as DELIVERY AVAILABLE or WE DELIVER!. The present process displays the delivery indicator 28 in the search results to notify the consumer as to whether a business is offering deliver service or not at the time of the search query. Subsequently, if the business is not offering deliver service at the time of the search query, the DELIVERY AVAILABLE or WE DELIVER! icon and/or terms will be omitted. Any combination of words, terms, phrases, or icons can be used to convey whether a business is offering deliver service or not.

FIG. 5 show a business profile page that appears when a consumer hits a desired business listing of FIG. 4. The present process displays the open now icon 27 in the business profile to notify the consumer as to whether a business is operating or not operating at the time of the search query. Subsequently, if the business is not operating the present process will use a simple icon or term such as CLOSED. This will immediately alert the consumer that the business is not operating at the time of the search.

FIG. 5 show the delivery indicator 28 in the business profile to notify the consumer as to whether a business is offering deliver service or not at the time of the search query. Subsequently, if the business is not offering deliver service at the time of the search query, the DELIVERY AVAILABLE or WE DELIVER! icon and/or terms will be omitted. Any combination of words, terms, phrases, or icons can be used to convey whether a business is offering a deliver service or not.

FIG. 6 show a business information form whereby a business can input their business details to be stored into the system server. The information inputted will appear in business listing of FIG. 4 and business profile of FIG. 5 when related to the search query entered and initiated in FIG. 3. The business enters all relevant details pertaining to the business i.e. name, address, telephone number, type of business. The information is entered into the system server for later retrieval by search queries in accordance with the method and system of the present process.

FIG. 7 show a continuation of the business information form of FIG. 6 featuring input fields for a business hours of operation. A business can input their business hours of operation to be stored into the system server. The information inputted will appear in business listing of FIG. 4 and business profile of FIG. 5 when related to the search query entered and initiated in FIG. 3. The business enters all relevant details pertaining to the business hours of operation including opening and closing times. The information is entered into the system server for later retrieval by search queries in accordance with the method and system of the present process.

FIG. 8 show a continuation of the business information form of FIG. 7 featuring input fields for a business delivery times. Delivery times may differ from the hours of operation of FIG. 7. A business can input their delivery times to be stored into the system server. The information inputted will appear in business listing of FIG. 4 and business profile of FIG. 5 when related to the search query entered and initiated in FIG. 3. The business enters all relevant details pertaining to the business delivery times including starting and ending delivery times. The information is entered into the system server for later retrieval by search queries in accordance with the method and system of the present process.

### Operation

In operation one uses the present process on a multitude of devices such as a computer 22, a cellular phone 23, and a hand held device 25 connected to the internet 24 or an offline network. The network includes a server computer that is connected to a computer network, such as the Internet or an IP-based computer network. The server computer includes a server memory that stores information pertaining to business details and hours of operation.

The device generally has a user interface. A user interface is a type of display format that enables a user to choose commands, start programs, and see list of files and other options by pointing to a pictorial representations and lists of menu items on the screen. Choices can generally be activated by either a keyboard or a mouse.

Two input boxes are provided where a user can enter desired search criteria in accordance with the method and system of the present process. The first box is the keyword input box 10A. The keyword input box 10A is provided to enter keywords. A keyword is a word or phrase entered into a search engine in an effort to get the search engine to return matching and relevant results. The keyword describes what the consumer is looking for i.e. Pizza.

The second box is the location input box 11A. The location input box is provided to input the desired area where the consumer wishes to search. Location can be entered as a city, state, street, postal/zip code, or neighborhood.

In operation a requester initiates a search inquiry by entering keyword 10 and location 11 information into an online browser or a user interface 12. The requester clicks on a link to submit the search query 26 to the present process 13. In a single-action 13, the present process 13 extracts 14 information from the search query 26 and searches within the system server 16 for businesses listings 17 related to the keyword 10 and location 11.

The hours of operation tables 20 of these resulting related business listings 17 are then compared to the local time 19 of the requester. Subsequently the proximity 18 is calculated between the resulting related business listings 17 and the location 11 initially inputted by the requester.

Under control of the single-action query 13, search results 21 are instantaneously displayed as a table of related items 21, encompassing a list of business listings 17, related to the keyword 10 which are open and operating at the local time 19 of the search query 26, within close proximity 18 of the location 11 inputted by the requester. Where applicable delivery times 20A of the related businesses are compared to the local time 19 of the search query 26, and results are included in the table 21.

Each search result item is clearly marked 27, 28, 29 enabling an observer, at first glance, to quickly determine which items displayed are live, open and within the desired proximity. Thus, eliminating having to initiate further actions to retrieve more specific desired information.

### Advantages

From the description above, a number of advantages of some embodiments of my method for searching and displaying content in a directory become evident. The single-action searching system of the present process reduces the number of consumer interactions needed to find an item or a business.

The present process will eliminate the current need to carry out a multitude of tasks, clicks and steps before being transported to the desired business information. This will save consumers time and effort. The present process can also be used to determine which businesses are offering delivery services, specials, happy hours, etc. at the time of the search query.

Consumers will bypass a multitude of steps including:
(a) manually scanning and clicking through numerous business listing results;
(b) searching through various business websites for hour of operation tables;
(c) calling the business by telephone to see if the business is open, operating and providing a delivery service at the time of the query.

Instead, a user can use the one-click process and automatically view clearly marked displayed results of all businesses related to the keyword which are open and operating at the time of the query within close proximity of the location initially inputted. The method for searching and displaying content in a directory allows the consumer, at first glance, to quickly determine which items displayed are live, open and within the desired proximity. Thus, eliminating having to initiate further actions to retrieve more specific desired information.

### CONCLUSION, RAMIFICATION, AND SCOPE

Accordingly, the reader will see that process for searching and displaying content in a directory of the various embodiments can be used to quickly and easily find detailed business information in a new and improved user-friendly display. The process provides faster, more reliable, accurate search results simply by entering a keyword, a location and administering one click of the mouse.

Furthermore, the search and display process has the additional advantages in that:
in a single-action consumers can search a system for items and businesses open and operating at the precise time of the query;
search results include proximity, which calculates the distance between the business and the search query or requester;
search results include a deliver indicator, which tells the consumer if the business is offering delivery services at time of the query;
all of the above features are provided after just one click;
results are displayed in a table with clearly marked icons and terms;
it saves time because it allows the observer, at first glance, to determine which listing is best without having to investigate and click further;
it not only benefits the consumer but it benefits the business because consumers are less likely to abandoned the search due to frustration caused by having to administer endless clicks to arrive at the desired result. Consequently, businesses will experience increased sales and trading.

While my above description contains many specificities, these should not be construed as limitation on the scope, but rather as an exemplification of one embodiment thereof. Many other variations are possible. For example, the present process can be used within offline networks and intranet systems.

Thus the scope of the embodiments should be determined by the appended claims and their legal equivalents, rather than the examples given.

I claim:

1. A method of searching and displaying content in a directory, comprising:
under control of a server system,
(a) means for inputting a request for information into said server system; and in response to only a single action being performed;
(b) means for sending said request for related items to said server system;
under control of said single-action inquiry component of said server system,
(c) means for receiving said request;
(d) means for extracting information contained in said request for information;
(e) means for extracting said items from said server system related to said request;
(f) means for comparing local time to timetables of said items within said server system related to said request;
(g) means for determining proximity between the location of the requester and location of said items within said server system related to said request;
(h) receiving related items from said server system in response to said request;
(i) means for displaying said related items in a list, whereby said list contains items from said server system related to said request, which are open, operating, and trading at the time of said request, within close proximity of said requester.

2. The method of claim 1 wherein the displaying of information includes displaying information indicating the said single action.

3. The method of claim 1 wherein said server system is any combination of hardware or software designed to store information and provide services to clients.

4. The method of claim 1 wherein said single action is clicking a button.

5. The method of claim 1 wherein the requester is a person entering information into said server system.

6. The method of claim 1 wherein proximity is the distance between said item and the location inputted by said requester.

7. The method of claim 1 wherein said local time is the time of the query corresponding to the time zone of said requester.

8. The method of claim 1 wherein the display component is a software program that allows you to view various kinds of information on the Web.
